(19) United States
(12) Patent Application Publication
(10) Pub. No.: US 2013/0180672 A1
(43) Pub. Date: Jul. 18, 2013

(54) LIFTING TYPE VENETIAN BLIND

(71) Applicant: Jianming Yu, Ruian City (CN)

(72) Inventor: Jianming Yu, Ruian City (CN)

(73) Assignee: LANDER INDUSTRIAL (ZHEJIANG) CO., LTD., Jiaxing City, Zhejiang Province (CN)

(21) Appl. No.: 13/810,688

(22) PCT Filed: Aug. 3, 2010
(86) PCT No.: PCT/CN10/01176

§ 371 Date: Jan. 30, 2013

(30) Foreign Application Priority Data
Jul. 19, 2010 (CN) 201010229756.5

(51) Int. Cl. E06B 9/303

(52) U.S. Cl. CPC E06B 9/303
USPC 160/170

(57) ABSTRACT

A lifting Venetian blind having a rope lock device is equipped at an end of a head rail, a side cover is equipped at another end of the head rail, a piece of transverse shaft is equipped in a head rail assembly system, an end of the piece of transverse shaft is loaded in the rope lock device, and another end of the piece of transverse shaft is equipped with elevator components, which include an elevator connection seat, a ladder belt cover wheel brake shaft, a cloth wheel stop bit elastic device, a ladder belt cover wheel, a bearing block, a bearing, and an elevator belt rotating wheel. It solves a problem of light leaking through a hole on a blind slat to the greatest extent possible. When the blind is raised or lowered, an elevator belt is easily on and off and not mutually winding knot without noise.

### TECHNICAL FIELD

The present invention relates to a kind of lifting Venetian blind.

### BACKGROUND ART

A traditional Venetian blind consists of a plurality of slats, a head rail, a bottom rail, a raising mechanism and an adjustment or tilting mechanism of such components. Each of the plurality of slats is provided with two holes. A raising cord passes through the two holes of the blind slat. The plurality of slats are raised and lowered by manipulating the raising cord to drive a metal worm and a worm gear. The inclination angle of the each slat is adjusted by actuating a tilting control wand. When the plurality of slats are in a horizontal position, the Venetian blind is in a fully open state. When the plurality of slats are tilted up or down at a certain angle with the horizontal, the Venetian blind is in a half-closed state or in a closed state. Because the holes are provided in the plurality of slats, the Venetian blind, even if it is in a fully closed state, can not completely block the light leaks coming through the holes. Thus, the shading effects of the Venetian blind are affected. Because both mentioned sets of mechanisms adjust the raising and lowering and tilt of the plurality of slats through the operations of the raising cords and tilting cords or the tilting control wand respectively. The utilizing of two sets of adjusting and raising mechanisms increases production cost, inconvenient operation and affects a concise and bright appearance of the Venetian blind.

China invention patent ZL200920150083.7 described a Venetian blind that the moving and the tilting angle of the plurality of slats are completed by a transmission operated by one set of adjusting mechanism and one raising cord. The Venetian blind consists of a plurality of slats, a head rail assembly system, a bottom rail and a raising cord. The ladder strings are equipped on the corresponding places of the holes of the plurality of slats and on the front side and the back side of the slats. A side cover is equipped at the other end of the head rail and a lock rope device is equipped at the end of a head rail assembly system. A piece of transverse shaft is equipped between the side cover and the lock rope device. The upper raising cord is installed in the lock rope device. A regulator connection seat is equipped on the piece of transverse shaft and a corresponding place of the slats. A double barrel is equipped on the piece of transverse shaft and the regulator connection seat. A driving wheel is equipped on one side of the double barrel. The front side and the back side of the upper edge of the ladder string are respectively equipped on the driving wheel. The blind slats connection rope is equipped on the double barrel.

The present invention solves the inconvenience of the traditional Venetian blind and a high cost. Compared with the previous Venetian blinds, the leaking light the hole on each of the plurality of slats is also reduced. But there are still some aspects in need of improvement. For example, the hole on the blind slat is still large and may leak light. The blind slats connection rope is winding on the barrel and it is possible to knot in a raising or lowering operation process. Once the connection rope is knotted, it would seriously influence the use of the Venetian blind. The friction force between the connection rope and the barrel is greater and the operation is not easy, and makes big noise. The structure of the barrel occupies the most space of the head rail assembly system. It causes the obstacles of installing a motor in the head rail assembly system for a further improvement to realize an intelligent Venetian blind.

### SUMMARY OF THE INVENTION

Accordingly, the present invention provides a kind of lifting Venetian blind which solves the problem of light leak to a great extent, becomes knotless, easy to operate and noiseless, and saves orbital space so that enable to install a motor in the Venetian blind.

The embodiments described herein provide a kind of lifting Venetian blind comprising a plurality of slats with holes, and a head rail assembly system, and a bottom rail, and an elevator belt, and a raising cord, wherein a rope lockup device is equipped at the end of the head rail of said head rail assembly system, and a side cover is equipped at the other end of the head rail, and a piece of transverse shaft is equipped in said head rail assembly system, and the end of said piece of transverse shaft is loaded in said lock rope device and the other end of said piece of transverse shaft is through the elevator components, and the other end of said piece of transverse shaft is equipped with an elevator belt rotating wheel and a ladder string cover wheel brake shaft of the elevator components. The elevator components include an elevator connection seat, a ladder belt cover wheel brake shaft, a cloth wheel stop bit elastic device, a ladder belt cover wheel, a bearing block, a bearing, and an elevator belt rotating wheel, and said elevator components are installed in the head rail by the elevator connection seat. The end of said elevator belt is fixed with an inner chamber wall of said elevator belt rotating wheel, and the other end of said elevator belt is a first concentric stack and winding in the wheel groove of said elevator belt rotating wheel, then is in turn through a hole of said each of a plurality of slats and a ladder string horizontal grid line, and the other end of said elevator belt is installed on said bottom rail. The width of said elevator belt is 1-20 mm and the thickness is 0.05-1 mm. The both sides of the top of said ladder string are respectively through the two sides of said ladder belt cover wheel and is equipped on the top of said ladder belt cover wheel, the bottom end of said ladder string is repectively equipped on said bottom rail. The elevator belt ordinally across the hole of said plurality of slats and a ladder string horizontal grid line to connect and locate said plurality of slats. The raising cord is a closed ring draw cord, and the top side of said raising cord is set and installed on a rope rotating wheel of said rope lock device, and the end side of said raising cord is naturally drooping and is equipped with a pull handle.

Because of the use of the bearing and the elevator belt in said elevator components, the structure of the present invention makes the friction force smaller when operating the raising cord and not noisy with the light energy. And the design of the elevator belt makes the hole on the plurality of slats narrowed and reduces the light leak to the greatest extent possible. The elevator belt is a concentric stack and winding in order at the wheel groove of said elevator belt rotating wheel to avoid the problem that the connection rope mutually wind knot. The structure of said elevator components is reasonable and the connection is compact to save the space for the development and the demand of the intelligent Venetian blind.

Optimization is said elevator belt is woven with the steel wires, or the copper wires, or the aluminum wires and said elevator belt is a banded knitting which could be tortuously coiled. Another optimization is said elevator belt is a cloth woven with the polyester yarns, or the nylon wires and said elevator belt is a banded knitting which could be tortuously coiled. Another optimization is said elevator belt is plastics or nylon and extrudes to model and is banded knitting which could be tortuously coiled.

Optimization is said cloth wheel stop bit elastic device is made from metal. Its advantage is fatigue resistance is strong. Another optimization is said cloth wheel stop bit elastic device is made from elastic plastic. The advantage of this scheme is not easy to rust with lighter weight. Another optimization is said cloth wheel stop bit elastic device is made from fatigue resistance rubber. The plastic deformation is less possible to happen and said cloth wheel stop bit elastic device is not easy to rust.

Optimization is said elevator belt rotating wheel of said elevator components is equipped with the left and right elevator belt rotating wheels, and a bearing is installed respectively in each left and right elevator belt rotating wheel, and an inner hole of said elevator belt rotating wheel is matched installed with said piece of transverse shaft, and the excircles of said two bearings are equipped with said two bearing blocks, and said bearing block is installed in a plate locating slot of said elevator connection seat. Its advantage is that the end of the said elevator belt is convenient to be fixed with an inner chamber wall of said elevator belt rotating wheel. Another optimization is said elevator belt rotating wheel of said elevator components is an integral structure and is equipped with elevator belt rotating wheels at the left side and the right side, two bearings are installed respectively in each the left and right elevator belt rotating wheels, and an inner hole of said elevator belt rotating wheel is installed with said piece of transverse shaft, and both excircles of said two bearings is equipped with the said two bearing blocks, and the said bearing block is installed in a plate locating slot of the said elevator connection seat. The advantage of this scheme is that the integral structure of the said elevator belt rotating wheel is convenient for manufacture and assembly.

The transmission operation method of the lifting Venetian blind described herein includes:

pulling down the raising cord to drive the rope rotating wheel in the lock rope device rotating and then drive the piece of transverse shaft rotating, and drive the ladder belt cover wheel brake shaft and the elevator belt rotating wheel in the elevator components rotating. When the ladder belt cover wheel brake shaft is rotating, the ladder belt cover wheel is rotated and a horizontal angle of the plurality of slats changes. When the ladder belt cover wheel turns to 90°, then the cloth wheel stop bit elastic device drives the ladder belt cover wheel to stop. At this time the plurality of slats are in a fully closed state. Then the elevator belt rotating wheel continues to rotate. The plurality of slats are put down or packed up to the desired position by the elevator belt. Finally, the raising cord is locked by the lock rope device to finish the operations.

### BRIEF DESCRIPTION OF THE DRAWINGS

Embodiments are described below with reference to the drawings.

FIG. 1 is a structure scheme of an optimization of the lifting Venetian blind described herein.

FIG. 2 is a structure and connection scheme of the head rail assembly system in FIG. 1.

FIG. 2A is a scheme of the elevator components in FIG. 2.

FIG. 3 is a structure scheme of the elevator components in FIG. 2.

FIG. 4 is a connection scheme of the elevator belt rotating wheel and the bearing in FIG. 3.

FIG. 5 is a scheme of the elevator belt reel in FIG. 4.

FIG. 6 is a structure and connection scheme of the lock rope device and the piece of transverse shaft in FIG. 2.

FIG. 7 is a structure and connection scheme of the lock rope device and the raising cord in FIG. 2.

### DETAILED DESCRIPTION OF THE PREFERRED EMBODIMENTS

Embodiments below are described with reference to the drawings. The lifting Venetian blind of the present invention includes the plurality of slats (1), a head rail assembly system (4), a bottom rail (8), a ladder string (2), an elevator belt (3), and a raising cord (5). The blind slat (1) has the hole (15). A rope lock device (13) (or called a head) is equipped at the end of a head rail (11) of the head rail assembly system (4). A side cover (9) is equipped at the other end of the head rail (11). A piece of transverse shaft (12) is equipped in said head rail assembly system (4), the one end of the piece of transverse shaft is loaded in the lock rope device and the other end of the piece of transverse shaft is through the elevator component (10). The other end of the piece of transverse shaft is equipped with an elevator belt rotating wheel (22) and a ladder belt cover wheel brake shaft (17) of the elevator components. The elevator component (10) includes an elevator connection seat (16), a ladder belt cover wheel brake shaft (17), a cloth wheel stop bit elastic device (18), a ladder belt cover wheel (19), a bearing block (20), a bearing (21), and an elevator belt rotating wheel (22). The elevator component (10) is installed in the head rail by the elevator connection seat (16). The one end of the elevator belt (3) is fixed on the elevator belt rotating wheel (22) (or called an elevator belt reel). The other end of the elevator belt (3) ordinally across through a hole (15) of the plurality of slats (1) and a ladder string horizontal grid line (6), and the other end of the elevator belt (3) is installed on the bottom rail (8). The top both sides of the ladder string (2) are respectively through the two sides of the ladder belt cover wheel (19) and is equipped on the top of the ladder belt cover wheel (19), and both bottom sides of ladder string (2) are respectively equipped on the bottom rail (8). The plurality of slats are in parallel across through in the lattice of the ladder string (2). A ladder string horizontal grid line (6) is set to support said plurality of slats and the angle of the plurality of slats can be adjusted by adjusting the ladder string horizontal grid line. The raising cord (5) is a closed rope, and the top end of the raising cord (5) is set and installed on a rope rotating wheel (24) of the rope lock device (13). The bottom end of the raising cord (5) is naturally drooping and is equipped with a pull handle (7).

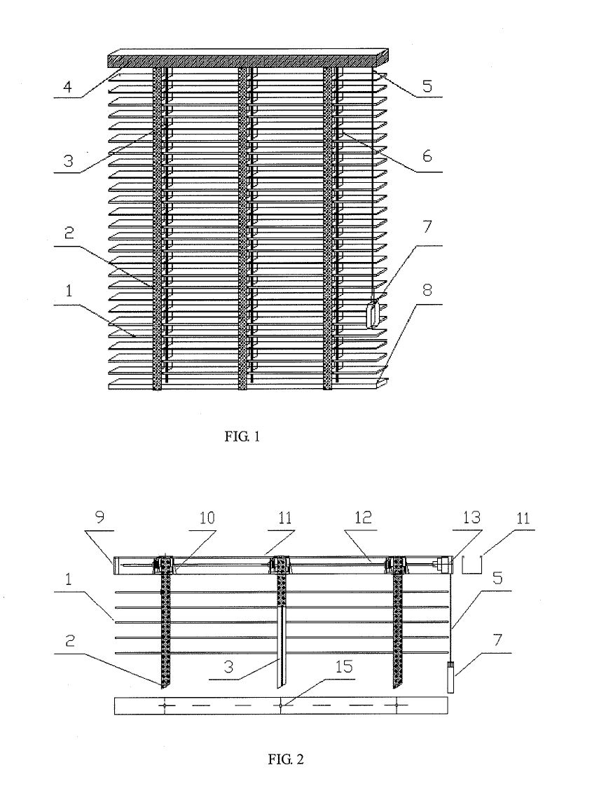

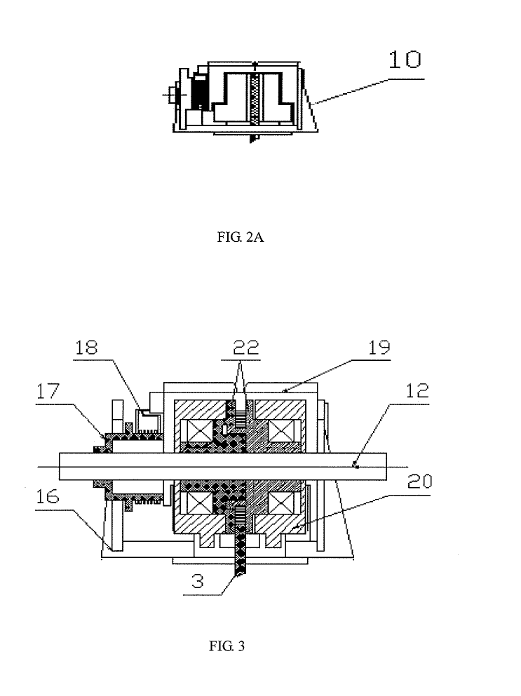

As depicted in FIG. 1, the ladder string (2) could be a ladder rope or a wide-brimmed ladder string to cover the hole on each of the slats so that preventing light leak. When the plurality of slats are put down and closed, the wide-brimmed ladder string completely blocks the outside light brought by the hole on the closed plurality of slats in order to avoid light leak.

As depicted in FIGS. 3 and 4 and 5, the elevator belt rotating wheel (22) of the elevator components (10) is equipped with the left and right elevator belt rotating wheels. A bearing (21) is respectively installed in each of the left and right elevator belt rotating wheels. The inner hole of the elevator belt rotating wheel (22) is installed with the piece of transverse shaft (12). Two excircles of the two bearings (21) are equipped with the two bearing blocks (20). The bearing block (20) is installed in a plate locating slot of the elevator connection seat (16). One end of the elevator belt (3) is fixed with an inner chamber wall of the elevator belt rotating wheel (22), and the other end of the elevator belt (3) is first concentric stacked and winding at a wheel groove (to rotate the elevator belt reel of the elevator belt rotating wheel 22) of the elevator belt rotating wheel (22), and then is through a wear belt hole of the connection seat plate of the elevator, then is in turn through a hole (15) of the plurality of slats (1) and a ladder string horizontal grid line (6). The other end of the elevator belt (3) is installed on the bottom rail (8).

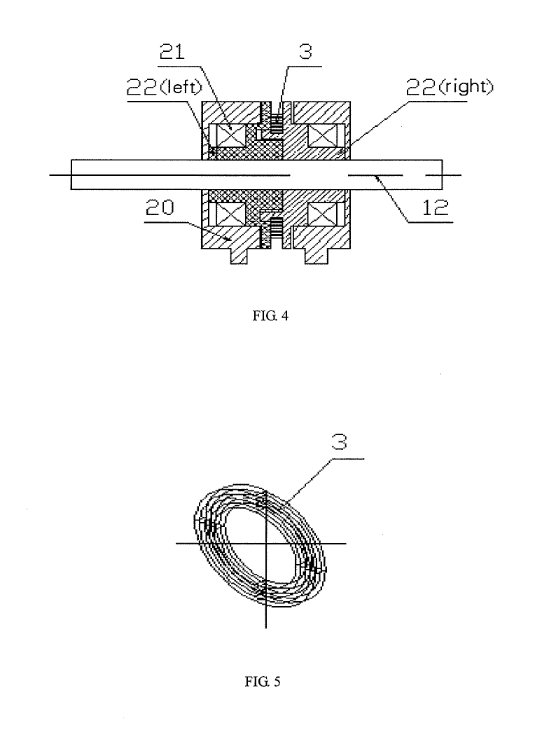

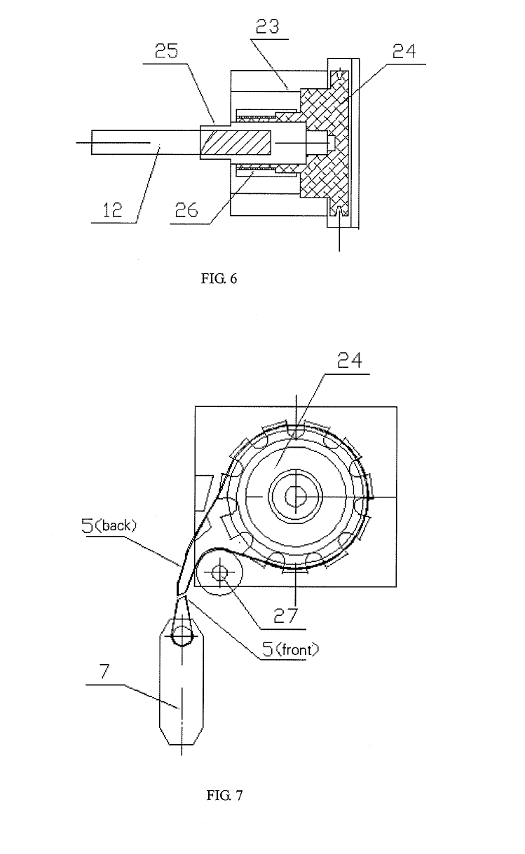

As depicted in FIGS. 6 and 7, the raising cord (5) is designed as a closed ring rope (as depicted in FIG. 4). The raising cord is divided into an anterior part and a posterior part. To pull the anterior part or the posterior part of the lifting drawscord (5), the rope rotating wheel (24) could bilaterally wind the elevator belt (3) to make the plurality of slats raise and lower.

The operation processes of the present invention includes: pull down the raising cord (5)→to drive the rope rotating wheel (24) in the rope lock device (13) (or called a head) rotating (such as in a clockwise direction)→to drive the piece of transverse shaft (12) rotating→to drive the ladder belt cover wheel (19) and the elevator belt rotating wheel (22) in the elevator components (10) rotating. When the ladder belt cover wheel (19) is rotating, a horizontal angle of the plurality of slats changes. When the ladder belt cover wheel turns to 90° (the rotating angle range is ±90°), then the ladder belt cover wheel brake shaft (17) in the elevator components (10) drives the cloth wheel stop bit elastic device (18) to stop. At this time the plurality of slats are in a fully closed state. Then the elevator belt rotating wheel (22) continues to rotate. The plurality of slats (1) are put down or packed up to the desired position by the elevator belt (3). Finally, the raising cord (5) is locked by the lock rope device (13) (or called a head) to stop the operations.

The detailed operation steps are:

(A) The Venetian blind is down (i.e., the plurality of slats are down). To pull down the posterior part of the raising cord (5) drives the lock rope device (13) (or called a head) and the piece of transverse shaft (12) and the ladder belt cover wheel (19) and the elevator belt rotating wheel (22) in the elevator components (10) to rotate. The plurality of slats (1) is down and fully closed.

(B) The blind is up (i.e., the plurality of slats are up). To pull down the anterior part of the raising cord (5) drives the lock rope device (13) (or called a head) and the piece of transverse shaft (12) and the ladder belt cover wheel (19) and the elevator belt rotating wheel (22) in the elevator components (10) to rotate in the reverse direction of the step (A), such as in a counter clockwise direction. Then the plurality of slats (1) is up and parallel overlapped to pack up.

(C) The angle of the plurality of slats is adjusted. When the Venetian blind is down, the anterior part of the raising cord (5) is pulled down and the ladder belt cover wheel (19) turns to 90°, such as in a counter clockwise direction, then the plurality of slats are in a parallel state. The posterior part of the raising cord (5) is pulled down, then the ladder belt cover wheel (19) rotates 180° in a clockwise direction. The plurality of slats is back closed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-18. (canceled)

19. A lifting Venetian blind comprises:
a plurality of slats with a hole,
a head rail assembly system,
a bottom rail,
a ladder string,
an elevator belt, and
a raising cord,
wherein a rope lock device is equipped at one end of a head rail of said head rail assembly system and a side cover is equipped at another end of the head rail, a piece of transverse shaft is equipped in said head rail assembly system, and one end of said piece of transverse shaft is loaded in said rope lock device and another end of said piece of transverse shaft is through an elevator component and is equipped with an elevator belt rotating wheel and a ladder belt cover wheel brake shaft.

20. The lifting Venetian blind of claim 19, wherein said elevator component includes an elevator connection seat,
a ladder belt cover wheel brake shaft,
a cloth wheel stop bit elastic device,
a ladder belt cover wheel,
a bearing block,
a bearing,
an elevator belt rotating wheel,
and said elevator component is installed in the head rail by the elevator connection seat.

21. The lifting Venetian blind of claim 19, wherein said elevator belt rotating wheel of said elevator component is equipped with left and right elevator belt rotating wheels, and two bearings are installed respectively in each left and right elevator belt rotating wheel; and an inner hole of said elevator belt rotating wheel is installed with said piece of transverse shaft, excircles of said two bearings are equipped with said two bearing blocks; said bearing block is installed in a plate locating slot of said elevator connection seat.

22. The lifting Venetian blind of claim 19, wherein said elevator belt rotating wheel of said elevator components is an integral structure and a bearing is installed respectively in each right and left side, and an inner hole of said elevator belt rotating wheel is matched installed with said piece of transverse shaft, the cylindrical of the two bearings is equipped with said two bearing blocks, said bearing block is installed in a plate locating slot of said elevator connection seat.

23. The lifting Venetian blind of claim 19, wherein one end of said elevator belt is fixed with an inner chamber wall of said elevator belt rotating wheel, and another end of the said elevator belt is a first concentric stack and winding at a wheel groove of said elevator belt rotating wheel, then is in turn through a hole of said slat and a ladder string horizontal grid line, and the other end of said elevator belt is installed on said bottom rail.

24. The lifting Venetian blind of claim 19, wherein two sides of a top of said ladder string are respectively through the two sides of said ladder belt cover wheel; the top of said ladder string is equipped on a top of said ladder belt cover wheel; the end of said ladder string is equipped on said bottom rail.

25. The lifting Venetian blind of claim 19, wherein said elevator belt is in across through a hole of said slat and a ladder string horizontal grid line to connect and locate said plurality of slats.

26. The lifting Venetian blind of claim 19, wherein said raising cord is a closed ring draw cord, and a top side of said raising cord is mounted on a rope rotating wheel of said rope lock device, and the end side of said raising cord is naturally drooping and is equipped with a pull handle.

27. The lifting Venetian blind of claim 19, wherein said elevator belt is bendable and windable band-like braided fabric which is woven from any one of steel wires, copper wires, aluminum wires, polyester yarns, nylon wires, squeezed plastic, or squeezed nylon.

28. The lifting Venetian blind of claim 20, wherein said cloth wheel stop bit elastic device is made from metal, elastic plastic, or anti-fatigue rubber.
